(19) United States
(12) Patent Application Publication
(10) Pub. No.: US 2024/0061129 A1
(43) Pub. Date: Feb. 22, 2024

(54) UPDATING GEOFENCING DATA IN A UTILITY VEHICLE CONTROL DEVICE

(71) Applicant: Textron Innovations Inc., Providence, RI (US)

(72) Inventor: Christopher Boehm, North Augusta, SC (US)

(21) Appl. No.: 17/890,836

(22) Filed: Aug. 18, 2022

(51) Int. Cl. G01S 19/42; G05D 1/02; H04W 4/021

(52) U.S. Cl. CPC G01S 19/42; G05D 1/0278; H04W 4/021; G05D 2201/0204

(57) ABSTRACT

Techniques are directed to operating a utility vehicle having global positioning system (GPS) circuitry and a geofencing data repository. Such techniques involve receiving, from the GPS circuitry, GPS output that indicates geolocation. The techniques further involve updating geofencing data within the geofencing data repository based on the GPS output that indicates geolocation. The techniques further involve, after updating the geofencing data, providing control to the utility vehicle based on the geofencing data within the geofencing data repository.

### BACKGROUND

A conventional golf cart management module may be preloaded with geofencing information for a specific golf course. During operation, the conventional golf cart management module uses the preloaded geofencing information to prevent a golf cart (or buggy) from driving off the golf course and/or into restricted areas (e.g., putting greens, ponds, etc.) of the specific golf course.

Additionally, the conventional golf cart management module periodically communicates with a central server that maintains a golf cart database. Entries in the golf cart database include factory-assigned golf cart identifiers (or serial numbers) that uniquely identify golf cart management modules among each other, and corresponding paths (e.g., addresses) to locations (e.g., remote servers) that store geofencing information for various golf courses.

To replace the preloaded geofencing information for the specific golf course on the conventional golf cart management module with new geofencing information for a new golf course, a human operator finds the particular entry in the golf cart database that contains the factory-assigned golf cart identifier that uniquely identifies the conventional golf cart management module. The human operator then overwrites the corresponding path within that entry with a new path to a new location that stores the new geofencing information for the new golf course. When the conventional golf cart management module subsequently communicates with the central server, the conventional golf cart management module sends its factory-assigned golf cart identifier to the central server and, in response, receives the new path from the central server. The conventional golf cart management module then uses the new path to retrieve the new geofencing information for the new golf course.

### SUMMARY

Unfortunately, there are deficiencies to the above-described conventional golf cart management module which requires a human operator to overwrite a path in a golf cart database in order to replace golf course geofencing information. For example, the human operator must find and modify an entry in the golf cart database which thus imposes manual complexity and causes delays in delivering the new geofencing information. Additionally, the entries of the golf cart database are required to include factory-assigned golf cart identifiers that uniquely identify the golf cart management modules.

In contrast to the above-described conventional golf cart management module which requires a human operator to overwrite a path in an entry of a golf cart database in order to replace golf course geofencing information, improved techniques are directed to a utility vehicle control device that provides control to a utility vehicle using locally stored geofencing data in which the locally stored geofencing data may be updated when the utility vehicle control device is no longer within a geo-site defined by the geofencing data. For example, the utility vehicle control device may control the propulsion system of a golf car, and may update first geofencing data that defines a first golf course with second geofencing data that defines a second golf course when the utility vehicle control device determines that the utility vehicle control device has been relocated from the first golf course to the second golf course. Such updating may be automatic thus minimizing update time. Additionally, such updating does not require any factory-assigned identifiers to uniquely identify the utility vehicle control device or require that such factory-assigned identifiers be maintained in a database managed by a human operator.

One embodiment is directed to a method of operating a utility vehicle having global positioning system (GPS) circuitry and a geofencing data repository. The method includes receiving, from the GPS circuitry, GPS output that indicates geolocation. The method further includes updating geofencing data within the geofencing data repository based on the GPS output that indicates geolocation. The method further includes, after updating the geofencing data, providing control to the utility vehicle based on the geofencing data within the geofencing data repository.

Another embodiment is directed to a utility vehicle control device which includes GPS circuitry, a geofencing data repository, and utility vehicle control circuitry coupled with the GPS circuitry and the geofencing data repository. The utility vehicle control circuitry is constructed and arranged to perform a method of:
(A) receiving, from the GPS circuitry, GPS output that indicates geolocation;
(B) updating geofencing data within the geofencing data repository based on the GPS output that indicates geolocation; and
(C) after updating the geofencing data, providing control to a utility vehicle based on the geofencing data within the geofencing data repository.

Yet another embodiment is directed to a utility vehicle that includes a utility vehicle body, a propulsion system supported by the utility vehicle body, and a utility vehicle control device coupled with the propulsion system. The utility vehicle control device includes GPS circuitry, a geofencing data repository, and utility vehicle control circuitry coupled with the GPS circuitry and the geofencing data repository. The utility vehicle control circuitry is constructed and arranged to perform a method of:
(A) receiving, from the GPS circuitry, GPS output that indicates geolocation;
(B) updating geofencing data within the geofencing data repository based on the GPS output that indicates geolocation; and
(C) after updating the geofencing data, providing control to the propulsion system of the utility vehicle based on the geofencing data within the geofencing data repository.

Another embodiment is directed to a computer program product having a non-transitory computer readable medium which stores a set of instructions to operate a utility vehicle having GPS circuitry and a geofencing data repository. The set of instructions, when carried out by computerized circuitry, causes the computerized circuitry to perform a method of:
(A) receiving, from the GPS circuitry, GPS output that indicates geolocation;
(B) updating geofencing data within the geofencing data repository based on the GPS output that indicates geolocation; and
(C) after updating the geofencing data, providing control to the utility vehicle based on the geofencing data within the geofencing data repository.

In some arrangements, the GPS output that indicates geolocation identifies a current location (e.g., GPS coordinates) of the utility vehicle. Additionally, updating the geofencing data within the geofencing data repository includes:
(i) based on the current location of the utility vehicle, detecting that the utility vehicle has been removed from a first geo-site that is defined by first geofencing data currently stored within the geofencing data repository, and
(ii) in response to detecting that the utility vehicle has been removed from the first geo-site, placing second geofencing data within the geofencing data repository.

In some arrangements, detecting that the utility vehicle has been removed from the first geo-site includes performing a geo-site comparison operation that compares the current location of the utility vehicle to the first geo-site that is defined by the first geofencing data. The geo-site comparison operation is configured to provide (i) a first result indicating that the first geofencing data is valid when the current location of the utility vehicle resides within the first geo-site, and (ii) a second result indicating that the first geofencing data is invalid when the current location of the utility vehicle does not reside within the first geo-site.

In some arrangements, the geo-site comparison operation provides the second result indicating that the first geofencing data is invalid. Additionally, placing second geofencing data within the geofencing data repository includes:
(i) transmitting an update request that identifies the current location of the utility vehicle to a data center, and
(ii) in response to transmitting the update request, receiving the second geofencing data from the data center and storing the second geofencing data within the geofencing data repository, the second geofencing data defining a second geo-site that is different from the first geo-site, the current location of the utility vehicle residing within the second geo-site.

In some arrangements, detecting that the utility vehicle has been removed from the first geo-site includes:
(i) based on the current location of the utility vehicle, performing a geofencing data lookup operation that identifies target geofencing data from a geofencing data lookup table; and
(ii) performing a geofencing data comparison operation that compares the target geofencing data to the first geofencing data currently stored within the geofencing data repository, a result of the geofencing data comparison operation indicating whether the target geofencing data matches the first geofencing data.

In some arrangements, the target geofencing data does not match the first geofencing data to indicate that the utility vehicle has been removed from the first geo-site. Additionally, placing the second geofencing data within the geofencing data repository includes:
(i) transmitting an update request that identifies the target geofencing data to a data center, and
(ii) in response to transmitting the update request, receiving the second geofencing data from the data center and storing the second geofencing data within the geofencing data repository, the second geofencing data defining a second geo-site that is different from the first geo-site, the current location of the utility vehicle residing within the second geo-site.

In some arrangements, placing the second geofencing data within the geofencing data repository includes automatically removing the first geofencing data from the geofencing data repository and storing the second geofencing data within the geofencing data repository in place of the first geofencing data.

In some arrangements, placing the second geofencing data within the geofencing data repository includes:
automatically performing a size comparison operation that compares a size of the second geofencing data to a remaining unused space metric that indicates an amount of remaining unused space within the geofencing data repository, and
(i) automatically storing the second geofencing data within the geofencing data repository within remaining unused space within the geofencing data repository when a result of the size comparison operation indicates that the amount of remaining unused space is larger than the size of the second geofencing data and (ii) automatically removing the first geofencing data from the geofencing data repository and storing the second geofencing data within the geofencing data repository in place of the first geofencing data when the result of the size comparison operation indicates that the amount of remaining unused space is smaller than the size of the second geofencing data.

In some arrangements, the utility vehicle is a golf car constructed and arranged to maneuver over golf course terrain. Additionally, the geofencing data within the geofencing data repository defines areas on a golf course. Furthermore, providing control to the utility vehicle includes limiting driving capabilities of the golf car (or other vehicle) within the areas of the golf course.

In some arrangements, limiting the driving capabilities of the golf car includes, based on the geofencing data within the geofencing data repository, disabling a propulsion system of the golf car in response to the golf car reaching boundaries of particular areas of the golf course.

In some arrangements, limiting the driving capabilities of the golf car includes, based on the geofencing data within the geofencing data repository, slowing a propulsion system of the golf car in response to the golf car reaching boundaries of particular areas of the golf course.

In some arrangements, the method further includes communicating geolocation indicated by the GPS output to a remote golf car management server. Accordingly, the remote golf car management server may provide further services such as track golf car location, distribute advertisements back to the golf car, monitor golf car status, transmit calls for service, and so on.

Other embodiments are directed to systems, vehicles/craft, apparatus, assemblies, and so on. Some embodiments are directed to various methods, systems, and componentry which are involved in updating geofencing data in a utility vehicle control device.

### BRIEF DESCRIPTION OF THE DRAWINGS

The foregoing and other objects, features and advantages will be apparent from the following description of particular embodiments of the present disclosure, as illustrated in the accompanying drawings in which like reference characters refer to the same parts throughout the different views. The drawings are not necessarily to scale, emphasis instead being placed upon illustrating the principles of various embodiments of the present disclosure.

FIG. 1 is a perspective view of a utility vehicle having a utility vehicle control device which updates geofencing data in accordance with certain embodiments.

FIG. 2 is a block diagram of a utility vehicle control device in accordance with certain embodiments.

FIG. 3 is a block diagram of electronic circuitry which is suitable for use for at least part of the utility vehicle control device in accordance with certain embodiments.

FIG. 4 is a diagram of an example geofencing data update process in accordance with certain embodiments.

FIG. 5 is a block diagram of example geofencing data in accordance with certain embodiments.

FIG. 6 is a block diagram of a geofencing data source listing in accordance with certain embodiments.

FIG. 7 is a flowchart of a procedure for providing control to a utility vehicle in accordance with certain embodiments.

FIG. 8 is a flowchart of a procedure for updating geofencing data in accordance with certain embodiments.

FIG. 9 is a flowchart of a procedure for accessing geofencing data within a local geofencing data repository in accordance with certain embodiments.

### DETAILED DESCRIPTION

An improved technique utilizes a utility vehicle control device that provides control to a utility vehicle using locally stored geofencing data which may be updated when the utility vehicle control device is no longer within a geo-site defined by the locally stored geofencing data. For example, the utility vehicle control device may control the propulsion system of a golf car, and may update first geofencing data that defines a first golf course with second geofencing data that defines a second golf course when the utility vehicle control device determines that the utility vehicle control device has moved from the first golf course to the second golf course. Such updating may be automatic thus minimizing geofencing data update time. Additionally, such updating does not require any factory-assigned identifiers to uniquely identify the utility vehicle control device or require that such factory-assigned identifiers be maintained in a database managed by a human operator.

The various individual features of the particular arrangements, configurations, and embodiments disclosed herein can be combined in any desired manner that makes technological sense. Additionally, such features are hereby combined in this manner to form all possible combinations, variants and permutations except to the extent that such combinations, variants and/or permutations have been expressly excluded or are impractical. Support for such combinations, variants and permutations is considered to exist in this document.

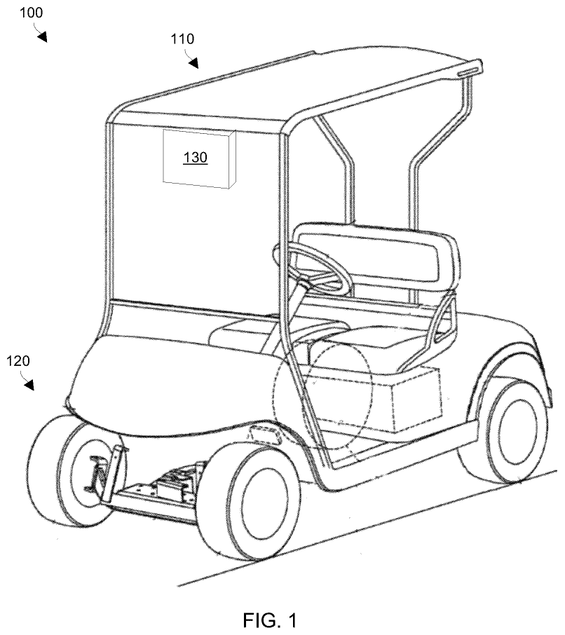

FIG. 1 shows a utility vehicle 100 that enjoys automated geofencing data updating in accordance with certain embodiments. The utility vehicle 100 includes a utility vehicle body 110 (e.g., a chassis, a frame, etc.), a propulsion system 120 supported by the utility vehicle body 110, and a utility vehicle control device 130 that couples with the propulsion system 120.

It should be understood that the utility vehicle 100 is shown in FIG. 1 as having the form factor of a golf car by way of example only and that other form factors are suitable for use as well such as those of personal transport vehicles, food and beverage vehicles, hospitality vehicles, all-terrain vehicles (ATVs), utility task vehicles (UTVs), motorcycles, scooters, snowmobiles, vehicles for specialized applications, as well as other lightweight vehicles and crafts. In the example context of a golf car, the propulsion system 120 may include a set of terrain engaging members such as a set of tires that operates to move the utility vehicle 100, accelerate/slow the utility vehicle 100, hold the utility vehicle 100 in place, and so on.

The utility vehicle body 110 is constructed and arranged to provide an operating platform that supports, among other things, the propulsion system 120. In some arrangements, the utility vehicle body 110 may define a passenger area having user controls (e.g., one or more foot pedals, a steering wheel, switches, etc.), seats, cargo carrying areas, storage areas, and so on. In some arrangements, the utility vehicle body 110 may define sections, compartments, and/or regions for housing/protecting/supporting other componentry such as an engine or motor, a set of batteries, control circuitry, specialized equipment, etc.

The propulsion system 120 is supported by the utility vehicle body 110, and is constructed and arranged provide propulsion for the utility vehicle 100. Along these lines, the propulsion system 120 may include one or more power sources (e.g., a set of batteries, a fuel tank, etc.), an electric motor or combustion engine, a steering system, a transmission/transaxle, brakes, etc. that operate to control movement of the utility vehicle 100.

The utility vehicle control device 130 couples with the propulsion system 120, and is constructed and arranged to manage location of the utility vehicle 100 based on locally stored geofencing data. For example, the utility vehicle control device 130 may disable the propulsion system 120 if the utility vehicle 100 reaches the boundary of a particular area (or geofence) to prevent the driver from inadvertently driving the utility vehicle 100 from the area. As another example, the utility vehicle control device 130 may impose speed limits on the propulsion system 24 when the utility vehicle 100 operates in certain speed limited areas to prevent the driver from damaging terrain or taking unnecessary risk in a difficult maneuvering area. In some arrangements, such control may be imposed by controlling power to the motor/engine, imposing a set of overriding control signals in place of one or more control signals from a set of user controls (e.g., an accelerator pedal, a forward/reverse switch, etc.), combinations thereof, and so on.

It should be understood that the utility vehicle control device 130 may take a variety of form factors. For example, the utility vehicle control device 130 may have the form factor of a small box (or brick) which can be located under a dashboard or within a storage area under a seat so that the utility vehicle control device 130 is normally hidden from driver view but easily serviceable. As another example, the utility vehicle control device 130 may have the form factor of a small tablet having user input/output (I/O) componentry such as a touchscreen display, a microphone, a camera, etc. (see FIG. 1) in order to provide additional services such as rendering location information to one or more passengers/operators, displaying geofence warnings/maps/notices/advertisements/time of day/menus for service/etc., receiving user input, etc. The utility vehicle control device 130 may further connect to other components such as a vehicle speaker and/or other output devices to provide further information, a vehicle power source, etc. Other form factors are suitable for use as well such as a combination of a tablet and a box/enclosure, a set of circuit boards, a portion of a motor controller and/or a battery management system, combinations thereof, etc.

During operation, the utility vehicle control device 130 provides control to the propulsion system 120 based on the locally stored geofencing data (e.g., speed control, gear selection, propulsion system enabling/disabling, etc.). Along these lines, the utility vehicle control device 130 may detect a current geolocation and compare the current geolocation to a geo-site defined by the locally stored geofencing data.

If the utility vehicle control device 130 detects that the current location does not reside within the geo-site defined by the locally storage geofencing data, the utility vehicle control device 130 may retrieve (e.g., via wireless communications) new geofencing data for a new geo-site covering the current geolocation. After such retrieval, the utility vehicle control device 130 may provide further control to the propulsion system 120 based on the newly retrieved geofencing data.

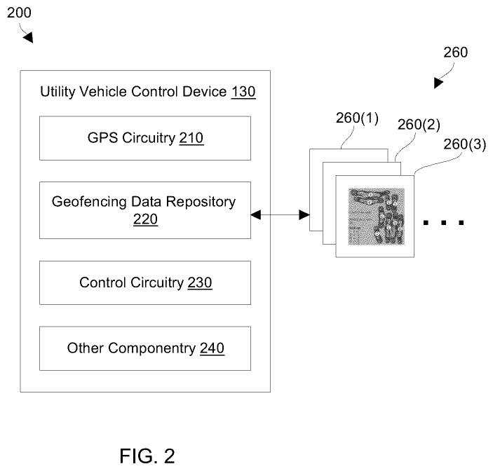

Such geofencing data retrieval may be performed automatically thus minimizing delay and requiring no manual intervention. Moreover, such geofencing data retrieval does not require any factory-assigned identifiers to uniquely identify the utility vehicle control device or require that such factory-assigned identifiers be maintained in a database managed by a human operator. Further details will now be provided with reference to FIG. 2.

FIG. 2 shows a view of various portions of the utility vehicle control device 130 in accordance with certain embodiments. As shown in FIG. 2, the utility vehicle control device 130 includes global position system (GPS) circuitry 210, a geofencing data repository 220, control circuitry 230, and other componentry 240.

The GPS circuitry 210 is constructed and arranged to provide GPS output that identifies the current location (or geolocation) of the utility vehicle control device 130. In accordance with certain embodiments, the GPS output provides location coordinates with relatively high precision relative to vehicle locating standards (e.g., within a few feet).

The geofencing data repository 220 is constructed and arranged to store one or more sets geofencing data 260(1), 260(2), 260(3), . . . (collectively, geofencing data 260) that defines one or more respective geo-sites depending on the amount of available memory and the size of the geofencing data 260. Along these lines, the geofencing data repository 220 may store geofencing data 260 for different types of geo-sites such as a golf course, a campus, a gated community, a shopping center, a parking complex, a warehouse, an enterprise facility, a military installation, a vacation resort, a recreational center, combinations thereof, and so on.

It should be understood that the geofencing data 260 is not simply mapping information. Rather, the geofencing data 260 defines different areas within a geo-site such as a normal area suitable for normal utility vehicle use, a restricted area that is suitable only for certain uses (e.g., traveling a low speed over a bridge), a prohibited area in which the utility vehicle is disabled from use (e.g., a putting green, a tee box, a pond, etc.), and so on.

The control circuitry 230 is constructed and arranged to provide control to a utility vehicle 100 based on the geofencing data 260 stored within the geofencing data repository 220. Such control may include speed control, enabling/disabling forward and/or reverse, outputting alerts/warning when the utility vehicle control device 130 has entered particular geofencing areas, left particular geofencing areas, reached boundaries for particular geofencing areas, combinations thereof, and so on.

Additionally, the control circuitry 230 may perform an auto-update operation that automatically stores new geofencing data within the geofencing data repository 220 based on the GPS output (e.g., GPS coordinates) from the GPS circuitry 220. For example, when the control circuitry 230 detects that the utility vehicle control device 130 has entered a new geo-site and discovers that the geofencing data 260 for the new geo-site is not currently stored within the geofencing data repository 220, the control circuitry 230 may automatically retrieve and store new geo-fencing data 260 for the new geo-site.

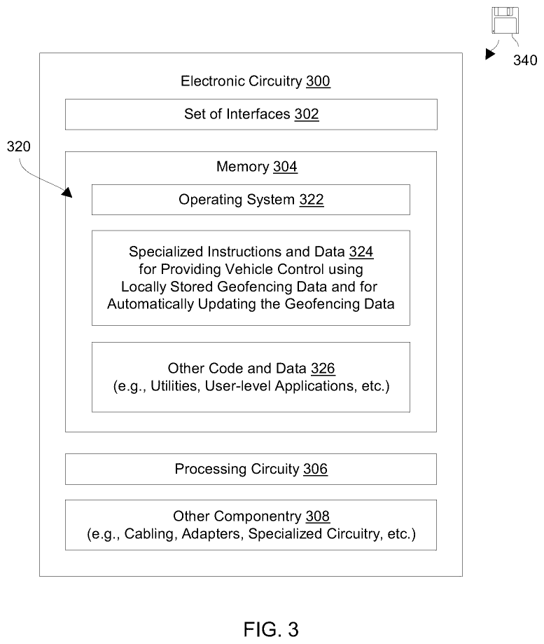

The other componentry 240 of the utility vehicle control device 130 refers to equipment such as a display screen (e.g., a tablet screen, a touchscreen, etc.), user controls (e.g., buttons, switches, etc.), motion detection circuitry (e.g., accelerometers, gyroscopes, etc.), power sourcing equipment (e.g., a power supply connector, a battery, etc.), other input/output componentry (e.g., a wireless transceiver, LEDs, etc.), interfaces (e.g., CANBUS, general I/O ports, etc.), and so on. Such other componentry 240 may be standard or optional in accordance with various embodiments. Further details will now be provided with reference to FIG. 3.

FIG. 3 is a block diagram of electronic circuitry 300 which is suitable for at least a portion of the control circuitry 230 (also see FIG. 2) of the utility vehicle control device 130 in accordance with certain embodiments. The electronic circuitry 300 includes a set of interfaces 302, memory 304, processing circuitry 306, and other circuitry 308.

The set of interfaces 302 is constructed and arranged to connect the electronic circuitry 300 with other components to enable the utility vehicle control device 130 to access such other components (FIG. 2). Along these lines, the set of interfaces 302 may include one or more internal interfaces (e.g., ports, buses, etc.) enabling the electronic circuitry 300 to access other local componentry such as the GPS circuitry 210, the geofencing data repository 220, etc. Additionally, the set of interfaces 302 may include one or more external interfaces (e.g., external ports, connectors, cables, jacks, etc.) enabling the electronic circuitry 300 to access external equipment such as the propulsion system 120 of the vehicle 100, and external power source, and so on.

The memory 304 is intended to represent both volatile storage (e.g., DRAM, SRAM, etc.) and non-volatile storage (e.g., flash memory, magnetic memory, etc.). The memory 204 stores a variety of software constructs 320 including an operating system 322, specialized instructions and data 324, and other code and data 326. The operating system 322 refers to particular control code such as a kernel to manage computerized resources (e.g., processor cycles, memory space, etc.), the I/O stack (e.g., drivers), and so on. The specialized instructions and data 324 refers to particular instructions for providing vehicle control using locally stored geofencing data, and auto-updating of the locally stored geofencing data. In some arrangements, the specialized instructions and data 324 is tightly integrated with or part of the operating system 322 itself. The other code and data 326 refers to applications and routines to provide additional operations and services (e.g., for advertisement display, to call for service, for playing a video of an area within the current geo-site, etc.), user-level applications, administrative tools, utilities, and so on.

The processing circuitry 306 is constructed and arranged to operate in accordance with the various software constructs 320 stored in the memory 304. As will be explained in further detail shortly, the processing circuitry 306 executes the operating system 322 and the specialized code 324 to form specialized circuitry that robustly and reliably provides vehicle control using locally stored geofencing data and automatically updates the geofencing data. Such processing circuitry 306 may be implemented in a variety of ways including via one or more processors (or cores) running specialized software, application specific ICs (ASICs), field programmable gate arrays (FPGAs) and associated programs, discrete components, analog circuits, other hardware circuitry, combinations thereof, and so on. In the context of one or more processors executing software, a computer program product 340 is capable of delivering all or portions of the software constructs 320 to the electronic circuitry 300. In particular, the computer program product 340 has a non-transitory (or non-volatile) computer readable medium which stores a set of instructions that controls one or more operations of the electronic circuitry 300. Examples of suitable computer readable storage media include tangible articles of manufacture and apparatus which store instructions in a non-volatile manner such as DVD, CD-ROM, flash memory, disk memory, tape memory, and the like.

The other componentry 308 refers to other hardware of the electronic circuitry 300. Along these lines, the electronic circuitry 300 may further include cabling, adaptors, auxiliary apparatuses, power supplies, other specialized componentry, combinations thereof, etc.

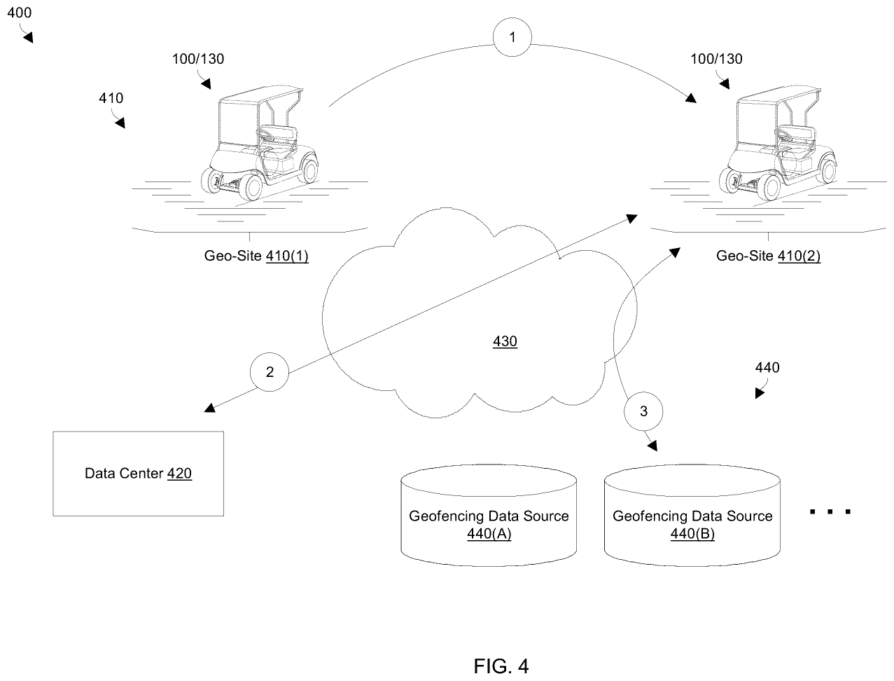

In accordance with certain embodiments, some or all of the electronic circuitry 300 may be integrated with other componentry. Along these lines, the memory 304 of the electronic circuitry 300 (FIG. 3) and the geofencing data repository 220 (FIG. 2) may share the same memory device(s) (e.g., the same solid state device, the same hard disk, combinations thereof, etc.). Additionally, the electronic circuitry 300 may be integrated with other vehicle electronics such as a motor controller, a battery management system, the processing circuitry of an autonomous driving system, combinations thereof, and so on. Further details will now be provided with reference to FIGS. 4 through 6.

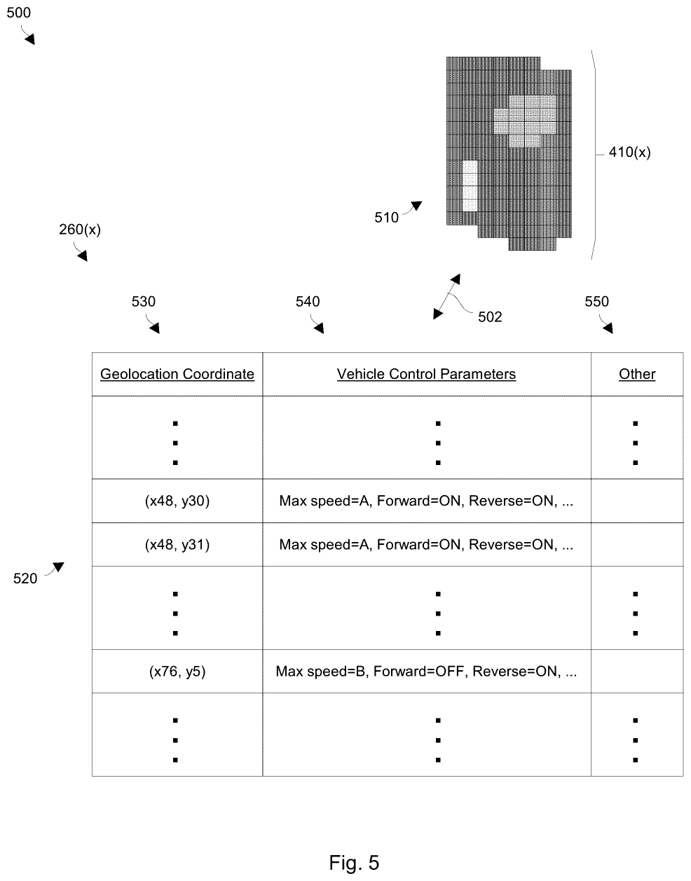

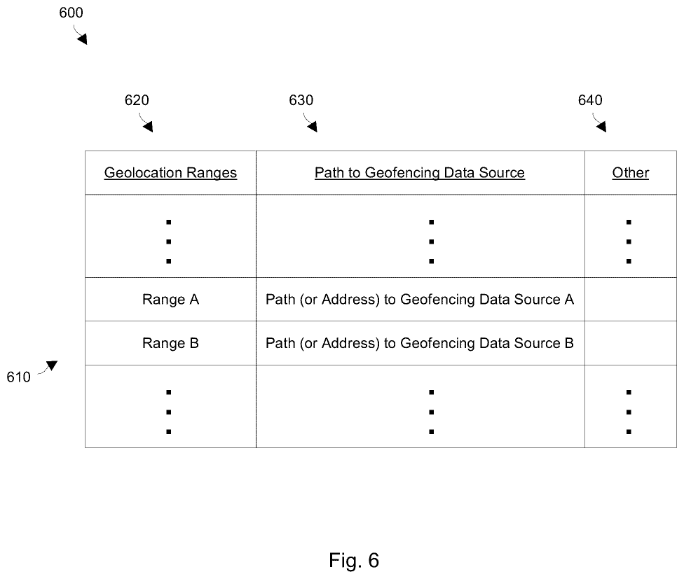

FIG. 4 shows a diagram 400 for an example geofencing data updating process. FIG. 5 shows a view 500 of example geofencing data 260 (also see FIG. 2) for a geo-site. FIG. 6 shows a view 600 of an example geofencing data source listing maintained by a data center.

As shown in FIG. 4, certain operations are performed by the utility vehicle control device 130 when the utility vehicle control device 130 is installed on a vehicle 100 (also see FIG. 1). Along these lines, the utility vehicle control device 130 has the ability to enable/disable the propulsion system 120, provide transmission/gear control (e.g., enable/disable forward, reverse, etc.), provide speed control, and/or control other operating aspects of the vehicle 100 (provide audio output to a speaker or buzzer, etc.). Additionally, the utility vehicle control device 130 has the ability to communicate with other external equipment.

Initially, suppose that the utility vehicle control device 130 stores geofencing data 260 (FIG. 2) that defines a geo-site 410(1) (e.g., a first golf course), and that the vehicle 100 resides within that geo-site 410(1). During this time, the utility vehicle control device 130 provides control to the propulsion system 120 of the vehicle 100 based on the GPS output (or coordinates) from the GPS circuitry 210 and the geofencing data 260. For example, the utility vehicle control device 130 may prevent the vehicle 100 from entering a restricted area (e.g., a putting green, the target area of a driving range, etc.) of the geo-site 410(1) based on current GPS output and the geofencing data 260. As another example, the utility vehicle control device 130 may lower the maximum speed of the vehicle 100 when the vehicle 100 is driving within certain areas of the geo-site 410(1) (e.g., crossing a small bridge, approaching a snack shack, etc.) based on current GPS output and the geofencing data 260. Other types of control are suitable as well such as alerting the driver via an audible alarm to indicate that the vehicle 100 has reached an area boundary of the geo-site 410(1), or allowing the vehicle 100 to reach a maximum speed when the vehicle 100 is in an open and flat fairway of the geo-site 410(1), and so on.

FIG. 5 shows a view 500 of example geofencing data 260(x) that defines an example geo-site 410(x) (see the double arrow 502) in accordance with certain embodiments. As shown in FIG. 5, the example geo-site 410(x) is divided (or partitioned) into an array of smaller areas 510 that are uniquely identifiable via GPS coordinates.

As further shown in FIG. 5, the example geofencing data 260(x) includes geofencing data entries 520 having geolocation coordinate fields 530, vehicle control parameter fields 540, and other fields 550. The geolocation coordinate fields 530 contain geolocation coordinates that uniquely identify the smaller areas 510 within the geo-site 410(x). The vehicle control parameter fields 540 contain vehicle parameters that the utility vehicle control device 130 controls. The other fields 550 contain additional items such as geo-site name, an area description, and so on.

By way of example only, when the utility vehicle control device 130 is within an area 510 indicated by “x48, y30” (as indicated by GPS output), an entry 520 within the geofencing data 260(x) directs the utility vehicle control device 130 to permit the vehicle 100 to have a maximum speed of A, enable the vehicle 100 to move forward, enable the vehicle 100 to move in reverse, and so on. Also, by way of example, when the utility vehicle control device 130 is within another area 510 indicated by “x76, y5”, another entry 520 within the geofencing data 260(x) directs the utility vehicle control device 130 to permit the vehicle 100 to have a maximum speed of B, prevent the vehicle 100 from moving forward, enable the vehicle 100 to move in reverse, and so on.

It should be understood that the geofencing data 260 that defines a geo-site 410 may take a variety of forms such as a set of files, a database, a spreadsheet, a directory containing subfolders, etc. Moreover, the geofencing data 260 may include additional information such as a range of GPS coordinates to enable quick determination as to whether a particular GPS coordinate resides within the geo-site 410, specialized configuration parameters to enable the utility vehicle control device 130 to control different types of utility vehicles 100, and so on.

At some point, suppose that the vehicle 100 is relocated from the geo-site 410(1) to another geo-site 410(2) (e.g., a second golf course) while the utility vehicle control device 130 remains installed on the vehicle 100. For example, an operator may control multiple golf courses and choose to move (or ship) one or more vehicles 100 from one golf course to another.

The transfer of the vehicle 100 from the geo-site 410(1) to the geo-site 410(2) is represented by the arrow 1 in FIG. 4. It should be understood that such movement may involve turning off the utility vehicle control device 130 and/or the vehicle 100 prior to transferring (or shipping) the vehicle 100 and turning back on the utility vehicle control device 130 and/or the vehicle 100 once the vehicle 100 arrives at the geo-site 410(2), although such turning off and on is not necessary.

When the utility vehicle control device 130 detects that it no longer resides within the geo-site 410(1), the utility vehicle control device 130 determines whether the utility vehicle control device 130 currently stores geofencing data 260 that defines a geo-site 410 covering its current location (e.g., geolocation defined by the current GPS output from the GPS circuitry 210). It should be understood that such detection may involve comparing the current GPS output from the GPS circuitry 210 to areas defined by all of the geofencing data 260 currently stored within the geofencing data repository 220.

If the utility vehicle control device 130 ascertains that there is no geofencing data 260 in the geofencing data repository 220 for its current location (e.g., based on GPS coordinates), the utility vehicle control device 130 attempts to obtain new geofencing data 260. Along these lines, the utility vehicle control device 130 communicates with a data center 420. Such communications may be over various communications media 430 which may include a computer network (e.g., Ethernet), a cellular network (e.g., 4G, 5G, etc.), other RF infrastructure and other wireless equipment (e.g., Bluetooth, etc.), the plain old telephone service (POTS), copper cabling and/or fiber optics, combinations thereof, and so on. The exchange between the utility vehicle control device 130 and the data center 420 is illustrated by the double arrow 2 in FIG. 4.

In accordance with certain embodiments, the utility vehicle control device 130 sends a geofencing data source request and its current location (e.g., defined by the current GPS output) to the data center 420. In response, the data center 420 identifies an accessible geofencing data source 440 from which the utility vehicle control device 130 may retrieve new geofencing data 260 for the geo-site 410(2). Along these lines, the data center 410 may perform a lookup operation that identifies new geofencing data 260 that defines the geo-site 410(2). Here, the data center 410 may maintain a listing of geo-site entries in which each geo-site entry identifies a respective geo-site 410 and a corresponding accessible geofencing data source 440 (e.g., remote servers) from which the utility vehicle control device 130 may retrieve new geofencing data 260 (e.g., see the geofencing data sources 440(A), 440(B), . . . in FIG. 4).

FIG. 6 shows a view 600 of a listing of geo-site entries 610 that identifies different geo-sites 410. Along these lines the geo-site entries 610 include geolocation range (or coordinate) fields 620, path fields 630, and other fields 640. The geolocation range fields 620 contain ranges of geolocation coordinates that uniquely identify particular geo-sites 410. The path fields 630 contain paths (or addresses) that enable the utility vehicle control device 130 to access geofencing data 260 from respective geofencing data sources 440 over the communications media 430. The other fields 550 contain additional items such as geo-site name, a name of the geo-site operator, and so on.

Once the data center 420 finds an entry for a geo-site 410 covering the current location from the listing, the data center 420 is able to identify an accessible geofencing data source 440. Accordingly, the data center 420 communicates the particular geofencing data source 440 to the utility vehicle control device 130 over the communications media 430 (arrow 2).

When the utility vehicle control device 130 receives this communication from the data center 420, the utility vehicle control device 130 retrieves the geofencing data 260 that covers the current location from the particular geofencing data source 440. Such retrieval may be via communications through the communications media 430. This exchange between the utility vehicle control device 130 and the particular geofencing data source 440 (e.g., the geofencing data source 440(B)) is illustrated by the double arrow 3 in FIG. 4.

It should be appreciated that the data center 420 and the geofencing data sources 440 may be operated by different entities. Along these lines, in the context of golf courses, different golf course operators may maintain respective geofencing data sources 440 (e.g., remote servers, cloud storage, etc.) and the data center 420 may be maintained by a separate entity (e.g., the utility vehicle control device 130 manufacturer, one or more suppliers, a golf course consortium, etc.). Moreover, within the listings, the accessible geofencing data sources 440 may be identified via network paths (or addresses), files (e.g., via NFS, via URL or web address, etc.), phone numbers, combinations thereof, etc.

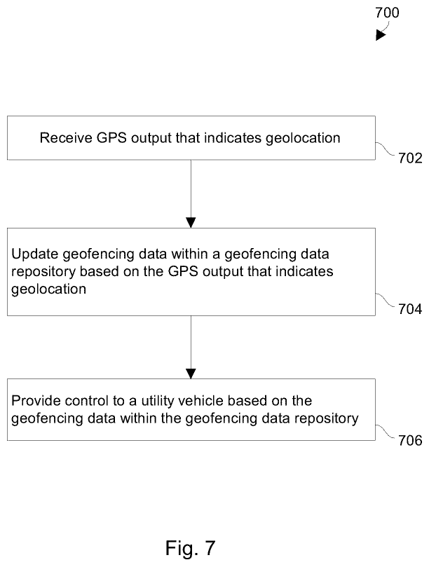

Additionally, it should be understood that the geofencing data sources 440 may offer access to geofencing data 260 for multiple geo-sites 410. In some arrangements, the data center 420 itself may further operate as a geofencing data source 440. Further details will now be provided with reference to FIGS. 7 through 9.

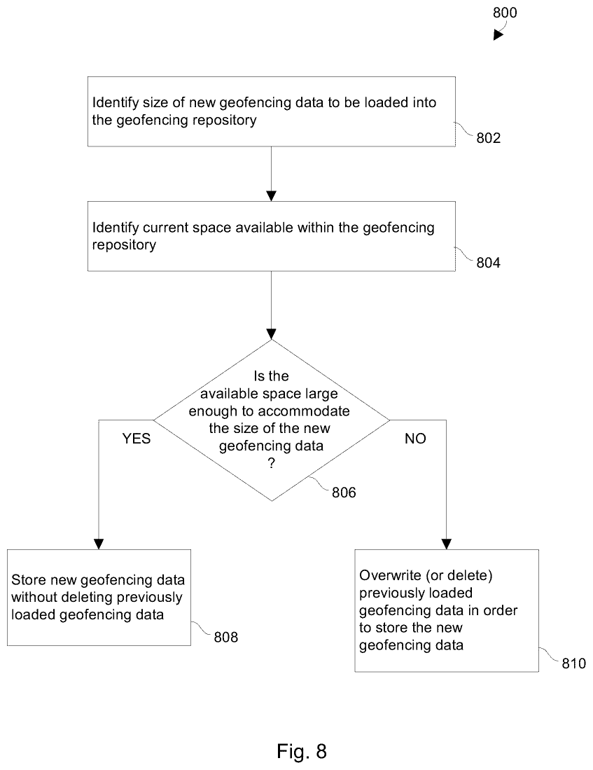

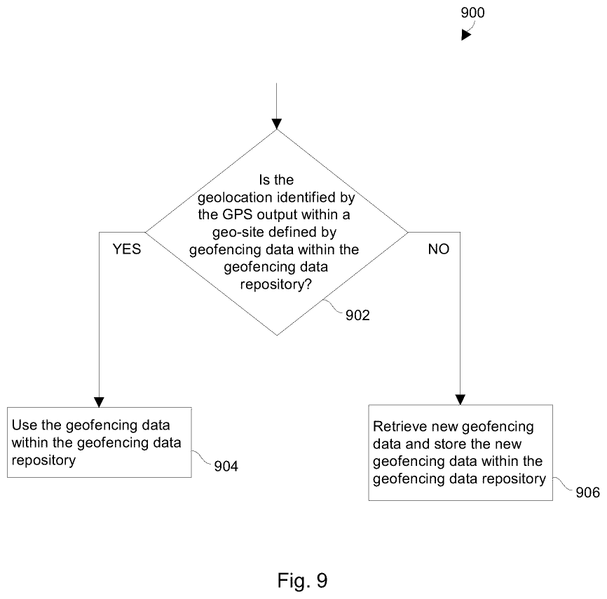

FIGS. 7 through 9 show certain procedures which may be performed by the utility vehicle control device 130. FIG. 7 shows a procedure 700 for providing control to a utility vehicle in accordance with certain embodiments. FIG. 8 shows a procedure 800 that includes certain details for updating the geofencing data in accordance with certain embodiments. FIG. 9 shows an alternative procedure 900 that includes certain details for determining whether to update the geofencing data in accordance with other embodiments.

In connection with FIG. 7, at 702, the utility vehicle control device 130 receives GPS output that indicates geolocation. Such GPS output (e.g., GPS coordinates) may be provided by a GPS circuit (or device) within the utility vehicle control device 130 (e.g., see the GPS circuitry 210 in FIG. 2) thus indicating a current location of the utility vehicle control device 130.

At 704, the utility vehicle control device 130 updates geofencing data within a geofencing data repository based on the GPS output that indicates geolocation. As mentioned earlier, such updating may be in response to the utility vehicle control device 130 being moved from one geo-site to another, the utility vehicle control device 130 automatically detecting the transfer based on GPS output.

At 706, after the geofencing data within the geofencing data repository is updated, the utility vehicle control device 130 provides control to the utility vehicle based on the geofencing data within the geofencing data repository utility vehicle control device 130. In particular, now that the geofencing data repository holds geofencing data for a current geo-site covering the current geolocation, the utility vehicle control device 130 is able to control the utility vehicle based on the GPS output and the geofencing data for the geo-site.

It should be understood that the geofencing data repository 220 may not be able to hold the geofencing data covering several geo-sites all at once. In accordance with certain embodiments, the utility vehicle control device 130 employs a simple approach to updating the geofencing data within the geofencing data repository. In particular, the utility vehicle control device 130 simply replaces existing geofencing data that is loaded within the geofencing data repository with new geofencing data. That is, the utility vehicle control device 130 overwrites (or deletes) the geofencing data that was previously loaded into the geofencing data repository with the new geofencing data.

In alternative embodiments, as shown in FIG. 8, the utility vehicle control device 130 performs a procedure 800 to smartly maintain space within the geofencing data repository 220. Such a procedure 800 enables the utility vehicle control device 130 to maintain the geofencing data 260 for multiple geo-sites within the geofencing data repository 220 at the same time if space permits.

At 802, the utility vehicle control device 130 identifies the size of new geofencing data to be loaded into the geofencing data repository 220. Such size identification may be received from a geofencing data source 440 prior to geofencing data retrieval (e.g., see the arrow 3 in FIG. 4).

At 804, the utility vehicle control device 130 identifies the amount of available space remaining within the geofencing data repository 220. Along these lines, even though there already exists preloaded geofencing data within geofencing data repository 220, the may be enough unused space left within the geofencing data repository 220 that is unnecessary to delete the existing geofencing data.

At 806, the utility vehicle control device 130 performs a comparison operation to determine whether there is enough space currently within the geofencing data repository 220. If so, 806 proceeds to 808. If not, 806 proceed to 810.

At 808, after the comparison operation indicates that there is enough space currently within the geofencing data repository 220, the utility vehicle control device 130 simply loads the new geofencing data into the geofencing data repository 220 without deleting the previously loaded geofencing data. Such a situation minimizes wear on the memory of the geofencing data repository 220 when the vehicle 100 is transferred between two geo-sites on a frequent or routine basis.

At 810, after the comparison operation indicates that there is not enough space currently within the geofencing data repository 220, the utility vehicle control device 130 overwrites (or deletes) the previously loaded geofencing data in order to store the new geofencing data within the geofencing data repository 220. Such a situation is suitable when memory within the geofencing data repository 220 is low (e.g., to minimize memory costs, when the geofencing data is excessively large, etc.).

FIG. 9 shows a procedure 900 which is performed by the utility vehicle control device 130 to trigger the geofencing data updating process. The procedure 900 may be event driven/triggered (e.g., performed when the utility vehicle control device 130 starts up or is reset, in response to an operator command, etc.) or periodically (e.g., daily, hourly, etc.), combinations thereof, etc. Alternatively, the procedure 900 may be performed in an ongoing manner (e.g., continuously as the GPS circuitry 210 of the utility vehicle control device 130 provides new GPS output).

At 902, the utility vehicle control device 130 detects whether the geolocation identified by the GPS output from the GPS circuitry 210 is within a geo-site defined by geofencing data within the geofencing data repository 220. If so, 902 proceeds to 904. If not, 902 proceeds to 906.

In some embodiments, the utility vehicle control device 130 performs a geo-site comparison operation that compares the current location of the utility vehicle to a geo-site that is defined by geofencing data within the geofencing data repository 220. A first result (or value) of the geo-site comparison operation indicates that the geofencing data is valid when the current location of the utility vehicle resides within a geo-site defined by the loaded geofencing data. A second result indicates that the geofencing data is invalid when the current location of the utility vehicle does not reside within a geo-site defined by the loaded geofencing data.

In other embodiments, the utility vehicle control device 130 identifies target geofencing data, and then performs a geofencing data comparison operation that compares the target geofencing data to the geofencing data currently stored within the geofencing data repository 220. A result (or value) of the geofencing data comparison operation indicates whether the target geofencing data matches the loaded geofencing data.

At 904, since the geolocation identified by the GPS output from the GPS circuitry 210 is within a geo-site defined by geofencing data within the geofencing data repository 220, the utility vehicle control device 130 uses the geofencing data within the geofencing data repository 220. As explained earlier, the utility vehicle control device 130 provides control to the utility vehicle 100 (e.g., speed control, forward/reverse control, etc.).

At 906, since the geolocation identified by the GPS output from the GPS circuitry 210 is not within a geo-site defined by geofencing data within the geofencing data repository 220, the utility vehicle control device 130 retrieves new geofencing data covering the current geolocation for the geofencing data repository 906 (also see FIG. 4). Once the utility vehicle control device 130 has retrieved the new geofencing data, the utility vehicle control device 130 uses the new geofencing data to provide control to the utility vehicle 100.

As described above, improved techniques are directed to a utility vehicle control device 130 that provides control to a utility vehicle 100 using locally stored geofencing data 260 in which the locally stored geofencing data 260 may be updated when the utility vehicle control device 130 is no longer within a geo-site 410 defined by the geofencing data 260. For example, the utility vehicle control device 130 may control the propulsion system of a golf car, and may update first geofencing data that defines a first golf course with second geofencing data that defines a second golf course when the utility vehicle control device 130 determines that the utility vehicle control device 130 has been relocated from the first golf course to the second golf course. Such updating may be automatic thus minimizing update time. Additionally, such updating does not require any factory-assigned identifiers to uniquely identify the utility vehicle control device 130 or require that such factory-assigned identifiers be maintained in a database managed by a human operator.

While various embodiments of the present disclosure have been particularly shown and described, it will be understood by those skilled in the art that various changes in form and details may be made therein without departing from the spirit and scope of the present disclosure as defined by the appended claims.

It should be understood that some golf car fleet management solutions involve using GPS devices that allow golf courses to operate efficiently while also improving the golfing experience. Such GPS devices help provide course information to the golfer such as video hole flyovers, terrain data, hole numbers, distances to greens, food and beverage options, etc. Such GPS devices also may provide input to the golf course operations team such as pace of play, vehicle locations, food and beverage orders, vehicle speeds, etc. The golf course operations team can also customize their golf course with geofences that prevent golf cars from traveling in areas that are not intended to be traveled in. These geofences can also limit the speed of a vehicle or serve as an advertisement with a pop-up image or video. For such solutions, each course requires a specific and tailored site.

A GPS device needs to download the course data on an internal hard drive. When a golf car is on the course, the GPS device is responsible for determining information like current pace of play, hole number, vehicle location, etc. The information gets sent to a central server in small batches every few seconds which gets displayed on the operations web site at the specific golf course.

Every golf course with such a solution has a specific site created that contains the course specific information that the GPS devices get assigned to. The current process of assigning GPS devices to sites is timely and requires the factory to pre-program the GPS devices to the specific course before shipping the GPS devices. Another challenge exists with multicourse facilities. Since sites are course specific the golf car with the GPS device on it will only function properly if it's used at its intended location. Customers with multiple courses occasionally prefer to reallocate vehicles to other courses for a certain amount of time. The course operators are required to provide the factory with cart vehicle numbers and the location they want to move the devices to so the factory can reallocate the vehicles.

In accordance with certain embodiments, improved techniques involve auto detection and download of golf course data on mobile fleet management devices. Along these lines, a “site” (or geo-site) is the location that a specialized circuitry may get programmed to. The site can be a collection of multiple courses, but it depends on the customer preference. The site contains all of the information required for the specialized circuitry to work efficiently at the course. The site also serves a storage file that contains the data that the specialized circuitry needs to download related to the specific course. A geofence is a customizable shape that is drawn over a satellite image of a targeted area. A geofence can be customized to send a variety of commands. Typically geofences are stored internally on the specialized circuitry so that it does not require a WIFI or cellular connection to trigger a geofence action. Since each device contains a GPS antenna it always knows its location and if its inside of a geofence or not.

In accordance with certain embodiments, a new type of “smart geofence” is drawn around an intended course. The smart geofence will contain the pathway to an accessible data center. When an unprogrammed device enters a smart geofence, the specialized circuitry sends a command via cellular or WIFI connection that will notify the data center which site to auto program to. The smart geofence will also be designed to allow vehicles to transfer to other sites. For example, a facility with multiple sites can transfer vehicles without the requirement of a support team. When the specialized circuitry enters a new smart geofence it will automatically transfer to the new site and download the necessary software.

The intent of this invention will remove the requirement of pre-programming GPS devices to specific sites. It will allow an un-assigned device to work at any course in the world. It will also allow customers with multi-course facilities the ability to reallocate vehicles to other courses without having to reprogram the GPS device. Such modifications and enhancements are intended to belong to various embodiments of the disclosure.

What is claimed is:

1. A utility vehicle control device, comprising:
global position system (GPS) circuitry;
a geofencing data repository; and
utility vehicle control circuitry coupled with the GPS circuitry and the geofencing data repository, the utility vehicle control circuitry being constructed and arranged to perform a method of:
receiving, from the GPS circuitry, GPS output that indicates geolocation;
updating geofencing data within the geofencing data repository based on the GPS output that indicates geolocation; and
after updating the geofencing data, providing control to a utility vehicle based on the geofencing data within the geofencing data repository.

2. The utility vehicle control device as in claim 1 wherein the GPS output that indicates geolocation identifies a current location of the utility vehicle; and
wherein updating the geofencing data within the geofencing data repository includes:
based on the current location of the utility vehicle, detecting that the utility vehicle has been removed from a first geo-site that is defined by first geofencing data currently stored within the geofencing data repository, and
in response to detecting that the utility vehicle has been removed from the first geo-site, placing second geofencing data within the geofencing data repository.

3. The utility vehicle control device as in claim 2 wherein detecting that the utility vehicle has been removed from the first geo-site includes:
performing a geo-site comparison operation that compares the current location of the utility vehicle to the first geo-site that is defined by the first geofencing data, the geo-site comparison operation being configured to provide (i) a first result indicating that the first geofencing data is valid when the current location of the utility vehicle resides within the first geo-site, and (ii) a second result indicating that the first geofencing data is invalid when the current location of the utility vehicle does not reside within the first geo-site.

4. The utility vehicle control device as in claim 3 wherein the geo-site comparison operation provides the second result indicating that the first geofencing data is invalid; and
wherein placing second geofencing data within the geofencing data repository includes:
transmitting an update request that identifies the current location of the utility vehicle to a data center, and
in response to transmitting the update request, receiving the second geofencing data from the data center and storing the second geofencing data within the geofencing data repository, the second geofencing data defining a second geo-site that is different from the first geo-site, the current location of the utility vehicle residing within the second geo-site.

5. The utility vehicle control device as in claim 2 wherein detecting that the utility vehicle has been removed from the first geo-site includes:
based on the current location of the utility vehicle, performing a geofencing data lookup operation that identifies target geofencing data from a geofencing data lookup table; and
performing a geofencing data comparison operation that compares the target geofencing data to the first geofencing data currently stored within the geofencing data repository, a result of the geofencing data comparison operation indicating whether the target geofencing data matches the first geofencing data.

6. The utility vehicle control device as in claim 5 wherein the target geofencing data does not match the first geofencing data to indicate that the utility vehicle has been removed from the first geo-site; and
wherein placing the second geofencing data within the geofencing data repository includes:
transmitting an update request that identifies the target geofencing data to a data center, and
in response to transmitting the update request, receiving the second geofencing data from the data center and storing the second geofencing data within the geofencing data repository, the second geofencing data defining a second geo-site that is different from the first geo-site, the current location of the utility vehicle residing within the second geo-site.

7. The utility vehicle control device as in claim 2 wherein placing the second geofencing data within the geofencing data repository includes:
automatically removing the first geofencing data from the geofencing data repository and storing the second geofencing data within the geofencing data repository in place of the first geofencing data.

8. The utility vehicle control device as in claim 2 wherein placing the second geofencing data within the geofencing data repository includes:
automatically performing a size comparison operation that compares a size of the second geofencing data to a remaining unused space metric that indicates an amount of remaining unused space within the geofencing data repository, and
(i) automatically storing the second geofencing data within the geofencing data repository within remaining unused space within the geofencing data repository when a result of the size comparison operation indicates that the amount of remaining unused space is larger than the size of the second geofencing data and (ii) automatically removing the first geofencing data from the geofencing data repository and storing the second geofencing data within the geofencing data repository in place of the first geofencing data when the result of the size comparison operation indicates that the amount of remaining unused space is smaller than the size of the second geofencing data.

9. The utility vehicle control device as in claim 1 wherein the utility vehicle is a golf car constructed and arranged to maneuver over golf course terrain;
wherein the geofencing data within the geofencing data repository defines areas on a golf course; and
wherein providing control to the utility vehicle includes:
limiting driving capabilities of the golf car within the areas of the golf course.

10. The utility vehicle control device as in claim 9 wherein limiting the driving capabilities of the golf car includes:
based on the geofencing data within the geofencing data repository, disabling a propulsion system of the golf car in response to the golf car reaching boundaries of particular areas of the golf course.

11. The utility vehicle control device as in claim 9 wherein limiting the driving capabilities of the golf car includes:
based on the geofencing data within the geofencing data repository, slowing a propulsion system of the golf car in response to the golf car reaching boundaries of particular areas of the golf course.

12. The utility vehicle control device as in claim 9, further comprising:
communicating geolocation indicated by the GPS output to a remote golf car management server.

13. A utility vehicle, comprising:
a utility vehicle body;
a propulsion system supported by the utility vehicle body; and
a utility vehicle control device coupled with the propulsion system, the utility vehicle control device including:
global position system (GPS) circuitry,
a geofencing data repository, and
utility vehicle control circuitry coupled with the GPS circuitry and the geofencing data repository, the utility vehicle control circuitry being constructed and arranged to perform a method of:
receiving, from the GPS circuitry, GPS output that indicates geolocation;
updating geofencing data within the geofencing data repository based on the GPS output that indicates geolocation; and
after updating the geofencing data, providing control to the propulsion system of the utility vehicle based on the geofencing data within the geofencing data repository.

14. The utility vehicle as in claim 1 wherein the utility vehicle is a golf car constructed and arranged to maneuver over golf course terrain;
wherein the geofencing data within the geofencing data repository defines areas on a golf course; and
wherein providing control to the propulsion system of the utility vehicle includes:
limiting driving capabilities of the golf car within the areas of the golf course.

15. The utility vehicle as in claim 14 wherein the GPS output that indicates geolocation identifies a current location of the golf car; and
wherein updating the geofencing data within the geofencing data repository includes:
based on the current location of the golf car, detecting that the golf car has been removed from a first golf course site that is defined by first geofencing data currently stored within the geofencing data repository, and
in response to detecting that the golf car has been removed from the first golf course site, placing second geofencing data within the geofencing data repository, the second geofencing data defining a second golf course site that is different from the first golf course site, the current location of the golf residing within the second golf course site.

16. The utility vehicle as in claim 15 wherein placing the second geofencing data within the geofencing data repository includes:
automatically removing the first geofencing data from the geofencing data repository and storing the second geofencing data within the geofencing data repository in place of the first geofencing data.

17. The utility vehicle as in claim 16 wherein detecting that the golf car has been removed from the first golf course site includes:
performing a golf course site comparison operation that compares the current location of the golf car to the first golf course site that is defined by the first geofencing data, the golf course site comparison operation being configured to provide (i) a first result indicating that the first geofencing data is valid when the current location of the golf car resides within the first golf course site, and (ii) a second result indicating that the first geofencing data is invalid when the current location of the golf car does not reside within the first golf course site.

18. The utility vehicle as in claim 16 wherein detecting that the golf car has been removed from the first golf course site includes:
based on the current location of the utility vehicle, performing a geofencing data lookup operation that identifies target geofencing data from a geofencing data lookup table; and
performing a geofencing data comparison operation that compares the target geofencing data to the first geofencing data currently stored within the geofencing data repository, a result of the geofencing data comparison operation indicating whether the target geofencing data matches the first geofencing data.

19. A method of operating a utility vehicle having global positioning system (GPS) circuitry and a geofencing data repository, the method comprising:
receiving, from the GPS circuitry, GPS output that indicates geolocation;
updating geofencing data within the geofencing data repository based on the GPS output that indicates geolocation; and
after updating the geofencing data, providing control to the utility vehicle based on the geofencing data within the geofencing data repository.
